(19) United States
(12) Patent Application Publication
(10) Pub. No.: US 2025/0060217 A1
(43) Pub. Date: Feb. 20, 2025

(54) SYSTEM AND METHOD FOR EFFICIENT DRIVING

(71) Applicant: GM Global Technology Operations LLC, Detroit, MI (US)

(72) Inventor: Harsh S. Purohit, Ann Arbor, MI (US)

(73) Assignee: GM Global Technology Operations LLC, Detroit, MI (US)

(21) Appl. No.: 18/450,915

(22) Filed: Aug. 16, 2023

(51) Int. Cl. G01C 21/34; G07C 5/02

(52) U.S. Cl. CPC G01C 21/3469; G01C 21/3492; G07C 5/02

(57) ABSTRACT

A method of optimizing energy consumption includes receiving vehicle route information, generating a baseline vehicle route profile including a baseline energy consumption and a baseline travel time, and processing the baseline vehicle route profile by detecting one or more changes in a road grade. For each detected change in the road grade, the method includes triggering a breakpoint to divide the baseline vehicle route profile into a plurality of segments, each segment in the plurality of segments having a baseline vehicle velocity, and for each segment in the plurality of segments, performing local optimization to generate a modified vehicle velocity. The method also includes generating an updated vehicle route profile and performing global optimization on the updated vehicle route profile to generate an optimized vehicle route profile, the optimized vehicle route profile having a different energy consumption than the baseline energy consumption.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against present disclosure.

The present disclosure relates generally to optimizing energy consumption for a vehicle. In both fossil fuel and electric powered vehicles, aerodynamic losses may impact the energy consumption of the vehicle. Generally, during a driving route, the vehicle velocity and the head wind velocity have the greatest impact on aerodynamic loss, of which vehicle velocity may be manipulated or adjusted to optimize energy consumption while balancing the travel time of the driving route.

### SUMMARY

In one configuration, a system and method includes receiving vehicle route information, generating a baseline vehicle route profile, the baseline vehicle route profile including an engine torque and an engine speed, generating, based on the engine torque and engine speed of the baseline vehicle route profile, a baseline energy consumption and a baseline travel time of the baseline vehicle route profile, and processing the baseline vehicle route profile by detecting one or more changes in a road grade of the baseline vehicle route profile. For each detected change in the road grade of the baseline vehicle route profile, the system and method triggers a breakpoint to divide the baseline vehicle route profile into a plurality of segments, each respective segment in the plurality of segments having a baseline vehicle velocity. For each respective segment in the plurality of segments of the baseline vehicle route profile, the system and method performs local optimization to generate a modified vehicle velocity and generates based on the modified vehicle velocity of each segment in the plurality of segments, an updated vehicle route profile. Finally, the system and method performs global optimization on the updated vehicle route profile to generate an optimized vehicle route profile, the optimized vehicle route profile having an optimized energy consumption that is different than the baseline energy consumption of the baseline vehicle route profile.

The system and method may include one or more of the following optional features. For example, the operations may further comprise providing the optimized vehicle route profile to a vehicle controller. The vehicle route information may comprise at least one of route map data, route grade data, vehicle head wind velocity, or vehicle local data. The vehicle local data may comprise at least one of vehicle mass, powertrain data, vehicle transmission gear ratios, or vehicle aerodynamic coefficients.

In one configuration, performing local optimization to generate a modified vehicle velocity may comprise receiving external route data, determining that the road grade is negative, and increasing the baseline vehicle velocity based a variance factor and the external route data. The external route data may comprise at least one of head wind velocity, traffic congestion, or traffic signal information. Additionally or alternatively, performing local optimization to generate a modified vehicle velocity may comprise receiving external route data, determining that the road grade is positive, and decreasing the baseline vehicle velocity based a variance factor and the external route data. The external route data may comprise at least one of head wind velocity, traffic congestion, or traffic signal information.

The operations may further comprise determining that a difference between an optimized travel time of the optimized vehicle route profile and the baseline travel time exceeds an acceptability threshold and generating, for output to a driver, a user-selectable option that when selected authorizes the optimized vehicle route profile. The user-selectable option may be provided as output from a user interface of a vehicle.

In another configuration, a system and method may include data processing hardware and memory hardware in communication with the data processing hardware, the memory hardware storing instructions that when executed on the data processing hardware cause the data processing hardware to perform operations comprising receiving vehicle route information, generating a baseline vehicle route profile, the baseline vehicle route profile including an engine torque and an engine speed, generating, based on the engine torque and engine speed of the baseline vehicle route profile, a baseline energy consumption and a baseline travel time of the baseline vehicle route profile, and processing the baseline vehicle route profile by detecting one or more changes in a road grade of the baseline vehicle route profile. For each detected change in the road grade of the baseline vehicle route profile, the system and method triggers a breakpoint to divide the baseline vehicle route profile into a plurality of segments, each respective segment in the plurality of segments having a baseline vehicle velocity. For each respective segment in the plurality of segments of the baseline vehicle route profile, the system and method performs local optimization to generate a modified vehicle velocity. The system and method generates, based on the modified vehicle velocity of each segment in the plurality of segments, an updated vehicle route profile. Finally, the system and method performs global optimization on the updated vehicle route profile to generate an optimized vehicle route profile, the optimized vehicle route profile having an optimized energy consumption that is different than the baseline energy consumption of the baseline vehicle route profile.

The system and method may include one or more of the following optional features. For example, the operations may further comprise providing the optimized vehicle route profile to a vehicle controller. The vehicle route information may comprise at least one of route map data, route grade data, vehicle head wind velocity, or vehicle local data. The vehicle local data may comprise at least one of vehicle mass, powertrain data, vehicle transmission gear ratios, or vehicle aerodynamic coefficients.

In one configuration, performing local optimization to generate a modified vehicle velocity may comprise receiving external route data determining that the road grade is negative, and increasing the baseline vehicle velocity based a variance factor and the external route data. The external route data may comprise at least one of head wind velocity, traffic congestion, or traffic signal information. Performing local optimization to generate a modified vehicle velocity may comprise receiving external route data, determining that the road grade is positive, and decreasing the baseline vehicle velocity based a variance factor and the external route data.

The external route data may comprise at least one of head wind velocity, traffic congestion, or traffic signal information. The operations may further comprise determining that a difference between an optimized travel time of the optimized vehicle route profile and the baseline travel time exceeds an acceptability threshold and generating, for output to a driver, a user-selectable option that when selected authorizes the optimized vehicle route profile. The user-selectable option may be provided as output from a user interface of a vehicle.

### BRIEF DESCRIPTION OF THE DRAWINGS

The drawings described herein are for illustrative purposes only of selected configurations and are not intended to limit the scope of the present disclosure.

FIGS. 1A and 1B are schematic views of an example system including an energy conservation system according to the principles of the present disclosure;

FIG. 2 is a schematic view of example components of the energy conservation system of FIGS. 1A and 1B;

FIG. 3 is a schematic view of a vehicle route plot including road grade changes; and

FIG. 4 is a flowchart of an example arrangement of operations for a method of optimizing energy consumption for a vehicle.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term module may be replaced with the term circuit. The term module may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term code, as used above, may include software, firmware, and/or microcode, and may refer to programs, routines, functions, classes, and/or objects. The term shared processor encompasses a single processor that executes some or all code from multiple modules. The term group processor encompasses a processor that, in combination with additional processors, executes some or all code from one or more modules. The term shared memory encompasses a single memory that stores some or all code from multiple modules. The term group memory encompasses a memory that, in combination with additional memories, stores some or all code from one or more modules. The term memory may be a subset of the term computer-readable medium. The term computer-readable medium does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

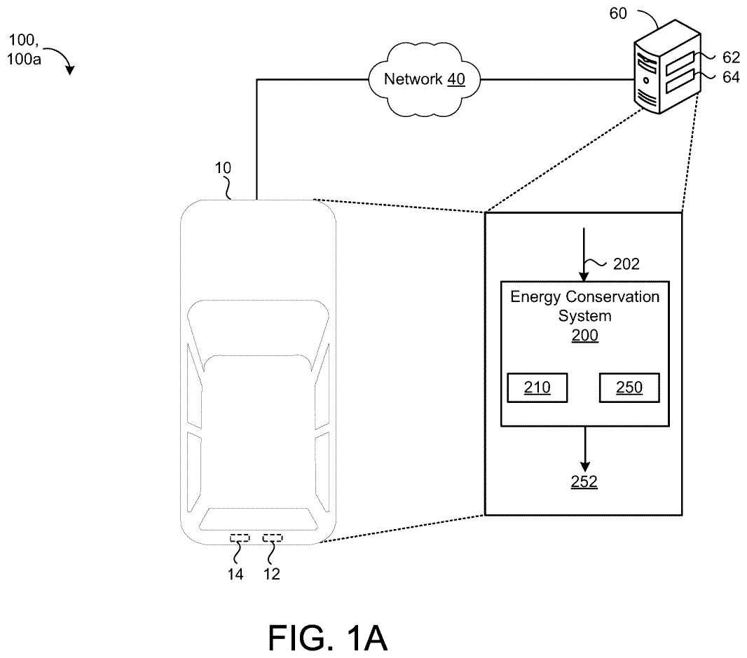

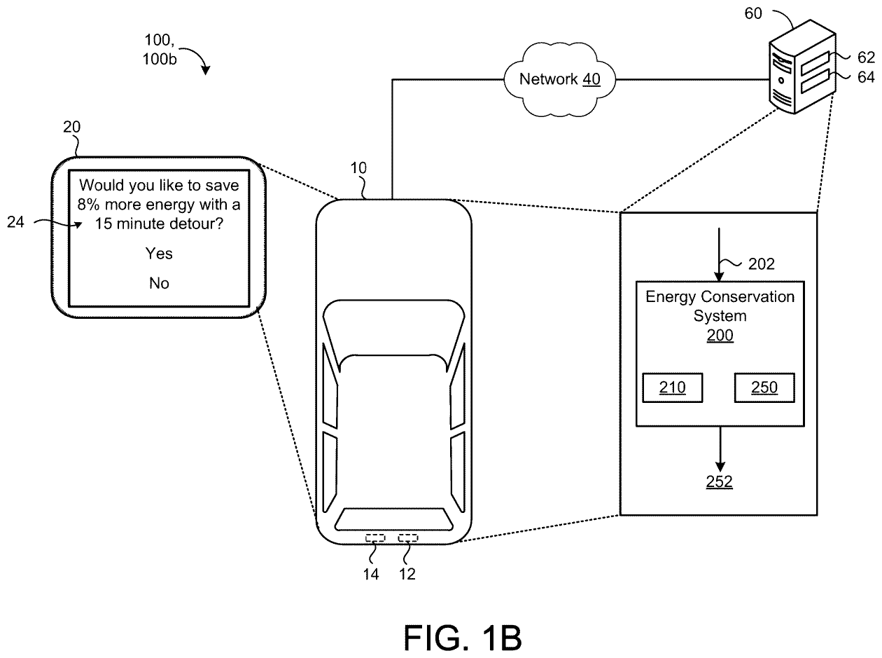

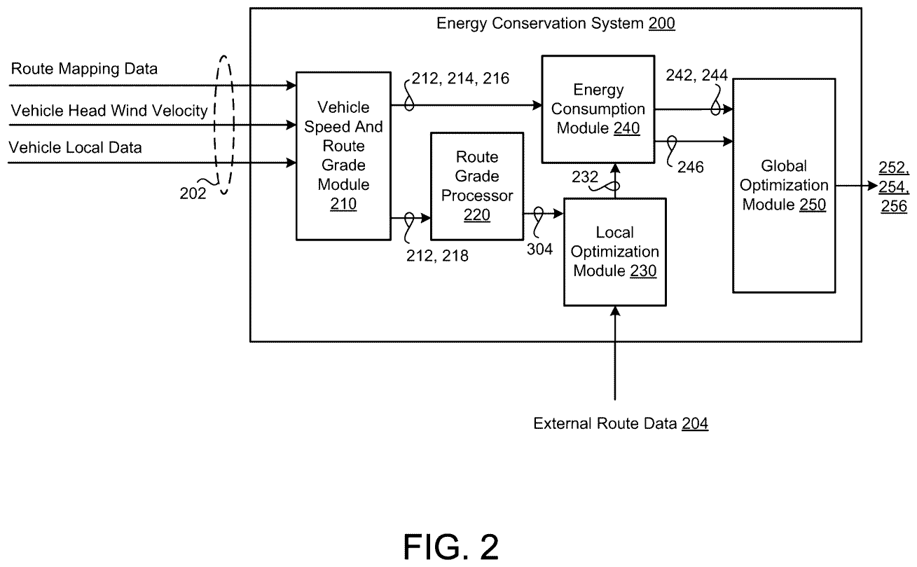

FIGS. 1A and 1B illustrate example systems 100a, 100b including a vehicle 10 and/or a remote system 60 in communication with the vehicle 10 via a network 40. The vehicle 10 and/or the remote system 60 executes an energy conservation system 200 that a user may engage when planning vehicle routes to generate optimized vehicle routes that conserve energy consumption of the vehicle 10. In the examples shown, the energy conservation system 200 is implemented within a vehicle 10. However, the energy conservation system 200 can be implemented on other computing devices (e.g., computing devices in communication with the vehicle 10), such as, without limitation, a smart phone, tablet, smart display, desktop/laptop, smart watch, smart appliance, headphones, smart glasses/headset, or a vehicle infotainment device. The vehicle 10 includes data processing hardware 12 and memory hardware 14 storing instructions that when executed on the data processing hardware 12 cause the data processing hardware 14 to perform operations. The remote system 60 (e.g., server, cloud computing environment) also includes data processing hardware 62 and memory hardware 64 storing instructions that when executed on the data processing hardware 62 cause the data processing hardware 62 to perform operations. In some examples, execution of the energy conservation system 200 is shared across the vehicle 10 and the remote system 60. As described in greater detail below with reference to FIG. 2, the energy conservation system 200 executing on the vehicle 10 and/or the remote system 60 executes a vehicle and route grade module 210, a route grade processor 220, a local optimization module 230, an energy consumption module 240, and a global optimization module 250. The energy conservation system 200 is configured to receive vehicle route information 202 for the vehicle 10 and generate an optimized vehicle route profile 252 that conserves energy of the vehicle 10 while limiting delays on the travel time of the vehicle 10.

The vehicle route information 202 may include at least one of route mapping data, vehicle head wind velocity, or vehicle local data, and may be stored on the vehicle 10 (e.g., the memory hardware 14) or may be received from the remote system 60. The vehicle 10 may receive the vehicle route information 202 in response to a driver of the vehicle 10 initiating a new planned route, or the vehicle 10 may receive the vehicle route information 10 without human interaction (e.g., for an autonomous route). The route mapping data may include, without limitation, the vehicle route, the posted vehicle speeds for the vehicle route, and road grade data for the vehicle route. The vehicle local data may include, without limitation, the vehicle payload, vehicle powertrain maps (e.g., brake-specific fuel consumption, torque curves, etc.), battery specifications, motor specifications, transmission gear ratios, and aerodynamic coefficients.

Referring to FIGS. 1A and 2, the vehicle 10 executes the energy conservation system 200 that receives, as input, the vehicle route information 202 and generates, as output, an optimized vehicle route profile 252. The energy conservation system 200 further includes a vehicle and route grade module 210, a route grade processor 220, a local optimization module 230, an energy consumption module 240, and a global optimization module 250. The vehicle route grade module 210 is configured to receive the vehicle route information 202 and generate a baseline vehicle route profile 212. The vehicle route profile 212 may include an engine torque Tₑ 214, an engine speed ωₑ 216, and a road grade 218 at any given time along the vehicle route profile 212. The engine torque Tₑ 214 at any given time along the vehicle route profile 212 may be expressed as follows:

$${T}_{e} = R / η [ {m}_{eff} \dot{v} + mg sin ϕ + γ mg cos ϕ + 1 / 2 \dot{ρ} A {{C}_{d} ( v + {v}_{w} )}^{2} ] \qquad ( 1 )$$

where R denotes the wheel radius of the vehicle, m_{eff} denotes the mass of the vehicle 10, the moment of inertia J of the rotating elements of the vehicle 10 and the wheel radius, g denotes the gravitational constant, γ denotes the rolling resistance coefficient of the vehicle, ϕ denotes the road grade 218, v_{w} denotes the headwind velocity, v denotes the vehicle velocity, \grave{ρ} denotes the air density at 25° C., A denotes the frontal area of the vehicle 10, and C_{d} denotes the air drag coefficient of the vehicle 10, and 71 can be expressed as follows:

$$η = {G}_{r} * FD \qquad ( 2 )$$

where Gᵣ denotes the gear ratio of the vehicle 10, and FD denotes the final drive ratio of the vehicle 10.

The engine speed ωₑ 216 at any given time along the vehicle route profile 212 may expressed as follows:

$${ω}_{e} = η . [ {ω}_{tire} ] \qquad ( 3 )$$

where ωₜᵢᵣₑ denotes the wheel speed of the vehicle 10.

Once the engine torque Tₑ 214 and an engine speed ωₑ 216 are generated as output from the vehicle speed and route grade module 210, the energy consumption model 240 may receive the engine torque Tₑ 214 and an engine speed ωₑ 216 as input and generate, as output, a baseline energy consumption 242 and a baseline travel time 244 of the baseline vehicle route profile 212. In other words, the energy consumption model 240 may determine the amount of energy and time the vehicle route will require without any optimization.

Additionally, the route grade processor 220 may receive the baseline vehicle route profile 212 including the road grade 218 along the baseline vehicle route profile 212 as input, and generate, as output, a plurality of segments 304, 304a-n of the baseline vehicle route profile 212. In particular, the route grade processor 220 processes the baseline vehicle route profile 212 by detecting one or more changes in the road grade 218. The changes may be any variation (e.g., positive, negative) in the road grade along the baseline vehicle route profile 212. For each detected change in the road grade 218 of the baseline vehicle route profile 212, the route grade processor 220 triggers a breakpoint 302 to divide the baseline vehicle route profile 212 into the plurality of segments 304. In other words, each segment 304 includes a single road grade 218.

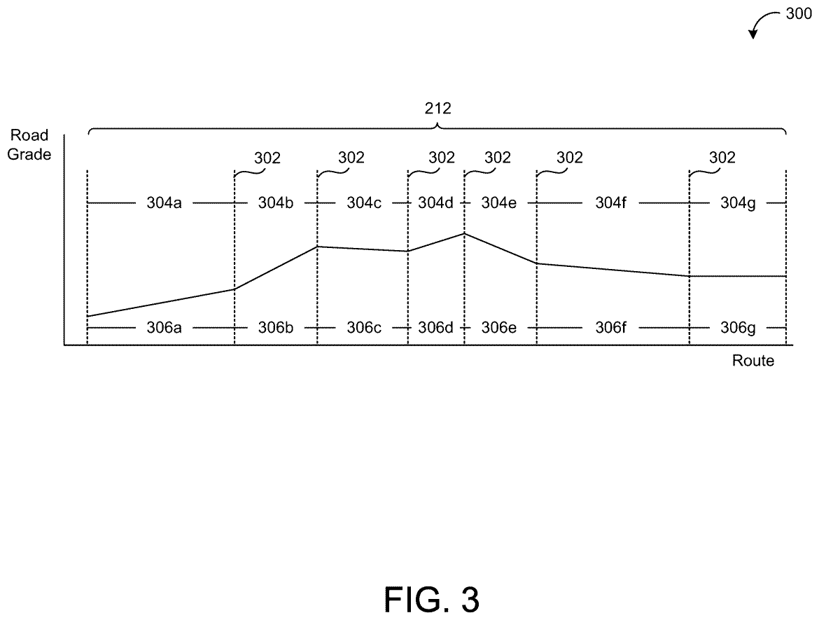

Each respective segment 304 in the plurality of segments 304 may include a baseline vehicle velocity ωᵥₑₕ 306, 306a-n that corresponds to the baseline vehicle route profile 212. For example, referring to FIG. 3, a schematic view 300 shows the road grade 218 of the baseline vehicle route profile 212 set on an x-axis representing a vehicle route and a y-axis representing a road grade. Here, the route grade processor 220 detects multiple changes in the road grade 218 and triggers breakpoints 302 to segment/divide the baseline vehicle route profile 212. As shown, the route grade processor 220 breakpoints 302 generate the baseline vehicle profile 212 into segments 304a-304g, where each of the segments 304a-304g includes a corresponding vehicle velocity ωᵥₑₕ 306-306g.

Referring again to FIGS. 1A and 2, the local optimization module 230 receives the plurality of segments 304 including the corresponding vehicle velocities ωᵥₑₕ 306 and, for each respective segment 304 in the plurality of segments 304, performs local optimization to generate a modified vehicle velocity ω_{veh_new} 232. In particular, the local optimization module 230 uses the road grade 218 of each respective segment 304 and applies a variance factor (e.g., 10% increase or 10% decrease) based on whether the vehicle is going uphill and should slow down to conserve energy, going downhill and should speed up to decrease the travel time, or maintain the speed of the vehicle 10 if the road grade is zero (0). The local optimization module 230 determines this, as follows:

$$if road grade < 0 , {ω}_{veh \_ new} = [ 1 : 1.1 ] \times {ω}_{veh} \\ if road grade > 0 , {ω}_{veh \_ new} = [ 0.9 : 1 ] \times {ω}_{veh} \\ if road grade = 0 , {ω}_{veh \_ new} = {ω}_{veh} \qquad ( 4 )$$

where (ω_{veh_new} denotes the modified vehicle velocity 232 for the segment 304, and ωᵥₑₕ denotes the baseline vehicle velocity 306 for the segment 304.

In addition to the road grade 218, the local optimization module 230 may include external route data 204 when generating the modified vehicle velocity (ω_{veh_new} 232 for each segment 304 of the baseline vehicle route profile 212. For example, the external route data 204 may include at least one of head wind velocity, traffic congestion along the vehicle route, or traffic signal information along the vehicle route. The external route data 204 may be detected by the vehicle 10, and/or may be received from the remote system 60 in communication with the vehicle 10 via the network 40. For example, the traffic congestion may be detected using image data captured by a camera system of the vehicle 10. Additionally or alternatively, the traffic congestion may be obtained by a satellite in communication with the remote system 60. Similarly, the head wind velocity may be received from a weather station in communication with the vehicle 10 and/or the remote system 10. The traffic signal information may be received from a traffic authority in communication with the vehicle and/or the remote system 10.

The energy consumption model 240 may receive the modified vehicle velocity ω_{veh_new} 232 for each segment 304 generated by the local optimization module 230 as input, and generate, as output, an updated vehicle route profile 246 by compiling the modified vehicle velocities ω_{veh_new} 232 for each segment 304. Thereafter, the global optimization module 250 may receive the baseline vehicle route profile 212 including the baseline energy consumption 242 and the baseline travel time 244, and the updated vehicle route profile 246 as inputs and generate, as output, an optimized vehicle route profile 252 including an optimized energy consumption 254 and an optimized travel time 256. Here, the optimized energy consumption 254 of the optimized vehicle route profile 252 is different than the baseline energy consumption 214 of the baseline vehicle route profile 212. The global optimization module 250 may execute an algorithm that, along the vehicle route, further refines the updated vehicle route profile 246 to minimize the energy consumption and travel time disruption to identify an optimal tradeoff between energy consumption and travel time. For example, the global optimization module 250 may determine that modifying the vehicle speed during segments 304a, 304e, and 304f would increase fuel efficiency of the vehicle 10 by 12%, while only increasing the travel time of the vehicle 10 by 6 minutes, and generate the optimized vehicle route profile 252 to include the modified vehicle velocity ω_{veh_new} 232 for the segments 304a, 304e, and 304f, while maintaining the baseline vehicle velocity ωᵥₑₕ 306 for the segments 304b-304d and 304g. In other examples, the global optimization module 250 may look up the corresponding least fuel consumption value for a segment 304 based on engine fuel consumption maps and output the corresponding engine torque Tₑ 214 and engine speed ωₑ 216 to calculate the gear ratio to maintain the vehicle speed.

In some examples, the energy conservation system 200 may provide the optimized vehicle route profile 252 to a vehicle controller of the vehicle 10. Here, the vehicle controller maintains the vehicle velocity based on the input optimized vehicle route profile 252. Referring to FIG. 1B, in some implementations, the global optimization module 250 determines that the difference between the optimized travel time 256 of the optimized vehicle route profile 252 and the baseline travel time 216 exceeds an acceptability threshold. For example, a manufacturer of the vehicle 10 may determine a route acceptability threshold that prevents the energy conservation system 200 from modifying the baseline vehicle route profile 212 when the optimized vehicle route profile 252 will significantly increase the travel time of the vehicle 10 and/or not have a significant improvement on fuel consumption of the vehicle. Here, when the difference between the optimized travel time 256 of the optimized vehicle route profile 252 and the baseline travel time 216 exceeds an acceptability threshold, the global optimization module 250 may not output the optimized vehicle route profile 252, and instead proceed with the baseline vehicle route profile 212.

Alternatively, as shown in FIG. 1B, the energy conservation system 200 may generate, for output to a driver of the vehicle 10 (or an operator of the vehicle 10), a user-selectable option 24 that when selected authorizes the optimized vehicle route profile 252. For example, the vehicle 10 may include or be in communication with a user interface 20. Here, the user-selectable option 24 may be output from the user interface 20 of the vehicle 10. As shown, the user interface 20 renders/displays a graphical element representing the user-selectable option 24 “Would you like to save 8% more energy with a 5 minute increase to the estimated time of arrival?” and includes the graphical elements for the user to select “Yes” or “No” before the vehicle 10 proceeds with the optimized vehicle route profile 252. In response to the user selecting the graphical element “Yes,” the energy conservation system 200 may provide the optimized vehicle route profile 252 to the vehicle controller of the vehicle 10.

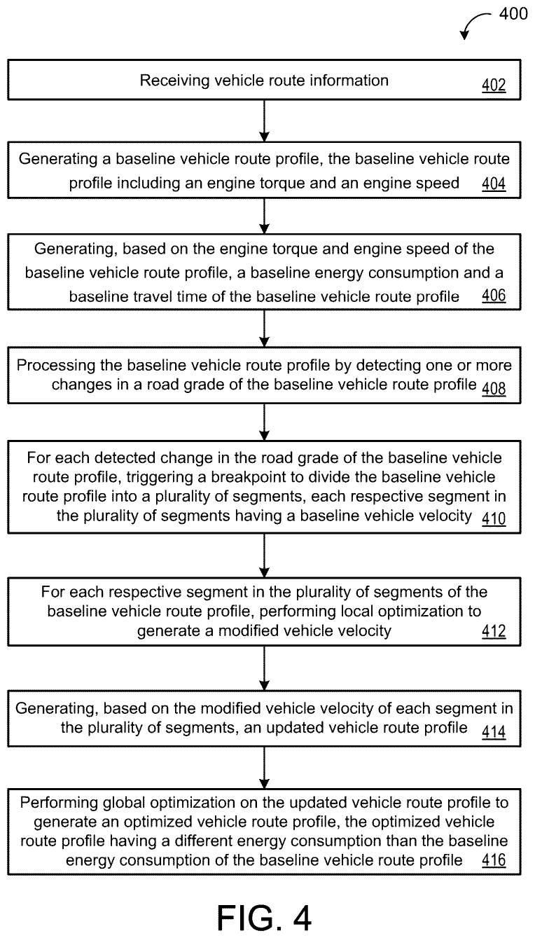

FIG. 4 includes a flowchart of an example arrangement of operations for a method 400 of optimizing energy consumption for a vehicle 10. At operation 402, the method 400 includes receiving vehicle route information 402. The method 400 also includes, at operation 404, generating a baseline vehicle route profile 212, the baseline vehicle route profile 212 including an engine torque Tₑ 214 and an engine speed ωₑ 216. At operation 406, the method 400 also includes, generating, based on the engine torque Tₑ 214 and an engine speed ωₑ 216 of the baseline vehicle route profile 212, a baseline energy consumption 242 and a baseline travel time 244 of the baseline vehicle route profile 212.

The method 400 also includes, at operation 408, processing the baseline vehicle route profile 212 by detecting one or more changes in a road grade 218 of the baseline vehicle route profile 212. For each detected change in the road grade 218 of the baseline vehicle route profile 212, the method 400 further includes, at operation 410, triggering a breakpoint 302 to divide the baseline vehicle route profile 212 into a plurality of segments 304, 304a-n. Here, each respective segment 304 in the plurality of segments 304 has a baseline vehicle velocity 306.

For each respective segment 304 in the plurality of segments 304 of the baseline vehicle route profile 212, the method 400 also includes, at operation 412, performing local optimization on the baseline vehicle velocity 306 to generate a modified vehicle velocity 232. At operation 414, the method 400 also includes generating, based on the modified vehicle velocity 232 of each respective segment 304 in the plurality of segments 304, an updated vehicle route profile 446. The method 400 also includes, at operation 416, performing global optimization on the updated vehicle route profile 446 to generate an optimized vehicle route profile 252. The optimized vehicle route profile 252 includes an optimized energy consumption 254 that is different than the baseline energy consumption 214 of the baseline vehicle route profile 212.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A computer-implemented method when executed on data processing hardware causes the data processing hardware to perform operations comprising:
receiving vehicle route information;
generating a baseline vehicle route profile, the baseline vehicle route profile including an engine torque and an engine speed;
generating, based on the engine torque and engine speed of the baseline vehicle route profile, a baseline energy consumption and a baseline travel time of the baseline vehicle route profile;
processing the baseline vehicle route profile by detecting one or more changes in a road grade of the baseline vehicle route profile;
for each detected change in the road grade of the baseline vehicle route profile, triggering a breakpoint to divide the baseline vehicle route profile into a plurality of segments, each respective segment in the plurality of segments having a baseline vehicle velocity;
for each respective segment in the plurality of segments of the baseline vehicle route profile, performing local optimization to generate a modified vehicle velocity;
generating, based on the modified vehicle velocity of each segment in the plurality of segments, an updated vehicle route profile; and
performing global optimization on the updated vehicle route profile to generate an optimized vehicle route profile, the optimized vehicle route profile having an optimized energy consumption that is different than the baseline energy consumption of the baseline vehicle route profile.

2. The method of claim 1, wherein the operations further comprise providing the optimized vehicle route profile to a vehicle controller.

3. The method of claim 1, wherein the vehicle route information comprises at least one of:
route map data;
route grade data;
vehicle head wind velocity; or
vehicle local data.

4. The method of claim 1, wherein the vehicle local data comprises at least one of:
vehicle mass;
powertrain data;
vehicle transmission gear ratios; or
vehicle aerodynamic coefficients.

5. The method of claim 1, wherein performing local optimization to generate a modified vehicle velocity comprises:
receiving external route data;
determining that the road grade is negative; and
increasing the baseline vehicle velocity based a variance factor and the external route data.

6. The method of claim 5, wherein the external route data comprises at least one of:
head wind velocity;
traffic congestion; or
traffic signal information.

7. The method of claim 1, wherein performing local optimization to generate a modified vehicle velocity comprises:
receiving external route data;
determining that the road grade is positive; and
decreasing the baseline vehicle velocity based a variance factor and the external route data.

8. The method of claim 7, wherein the external route data comprises at least one of:
head wind velocity;
traffic congestion; or
traffic signal information.

9. The method of claim 1, wherein the operations further comprise:
determining that a difference between an optimized travel time of the optimized vehicle route profile and the baseline travel time exceeds an acceptability threshold; and
generating, for output to a driver, a user-selectable option that when selected authorizes the optimized vehicle route profile.

10. The method of claim 9, wherein the user-selectable option is provided as output from a user interface of a vehicle.

11. A system comprising:
data processing hardware; and
memory hardware in communication with the data processing hardware, the memory hardware storing instructions that when executed on the data processing hardware cause the data processing hardware to perform operations comprising:
receiving vehicle route information;
generating a baseline vehicle route profile, the baseline vehicle route profile including an engine torque and an engine speed;
generating, based on the engine torque and engine speed of the baseline vehicle route profile, a baseline energy consumption and a baseline travel time of the baseline vehicle route profile;
processing the baseline vehicle route profile by detecting one or more changes in a road grade of the baseline vehicle route profile;
for each detected change in the road grade of the baseline vehicle route profile, triggering a breakpoint to divide the baseline vehicle route profile into a plurality of segments, each respective segment in the plurality of segments having a baseline vehicle velocity;
for each respective segment in the plurality of segments of the baseline vehicle route profile, performing local optimization to generate a modified vehicle velocity;
generating, based on the modified vehicle velocity of each segment in the plurality of segments, an updated vehicle route profile; and
performing global optimization on the updated vehicle route profile to generate an optimized vehicle route profile, the optimized vehicle route profile having an optimized energy consumption that is different than the baseline energy consumption of the baseline vehicle route profile.

12. The system of claim 11, wherein the operations further comprise providing the optimized vehicle route profile to a vehicle controller.

13. The system of claim 11, wherein the vehicle route information comprises at least one of:
route map data;
route grade data;
vehicle head wind velocity; or
vehicle local data.

14. The system of claim 11, wherein the vehicle local data comprises at least one of:
vehicle mass;
powertrain data;
vehicle transmission gear ratios; or
vehicle aerodynamic coefficients.

15. The system of claim 11, wherein performing local optimization to generate a modified vehicle velocity comprises:
receiving external route data;
determining that the road grade is negative; and
increasing the baseline vehicle velocity based a variance factor and the external route data.

16. The system of claim 15, wherein the external route data comprises at least one of:
head wind velocity;
traffic congestion; or
traffic signal information.

17. The system of claim 11, wherein performing local optimization to generate a modified vehicle velocity comprises:
receiving external route data;
determining that the road grade is positive; and
decreasing the baseline vehicle velocity based a variance factor and the external route data.

18. The system of claim 17, wherein the external route data comprises at least one of:
head wind velocity;
traffic congestion; or
traffic signal information.

19. The system of claim 11, wherein the operations further comprise:
determining that a difference between an optimized travel time of the optimized vehicle route profile and the baseline travel time exceeds an acceptability threshold; and
generating, for output to a driver, a user-selectable option that when selected authorizes the optimized vehicle route profile.

20. The system of claim 19, wherein the user-selectable option is provided as output from a user interface of a vehicle.
